(19) United States
(12) Patent Application Publication
(10) Pub. No.: US 2017/0297437 A1
(43) Pub. Date: Oct. 19, 2017

(54) CHARGING CONNECTION FOR AN ELECTRIC VEHICLE

(71) Applicant: Faraday&Future Inc., Gardena, CA (US)

(72) Inventors: Richard S. Kim, Los Angeles, CA (US); Chi Hung Cao, Huntington Beach, CA (US); Skyler R. Lund, La Crescenta, CA (US)

(21) Appl. No.: 15/490,820

(22) Filed: Apr. 18, 2017

Related U.S. Application Data
(60) Provisional application No. 62/324,739, filed on Apr. 19, 2016.

(51) Int. Cl. B60L 11/18; H02J 50/10; H04B 5/00

(52) U.S. Cl. CPC B60L 11/182; H04B 5/0037; H02J 50/10; B60L 11/1838

(57) ABSTRACT

Disclosed herein is a plugless and socketless charging connection for an electric vehicle. In some aspects, a conductive path is disposed in an exterior vehicle component. The conductive path may appear to be part of a door, fender, emblem, and the like. Current, sufficient to charge one or more batteries within the vehicle may pass through the conductive path. In some aspects, a charge port is also disposed within the vehicle. The charge port may be movable from at least a first position spaced away from the conductive path to a second position in contact with at least a portion of the conductive path.

### CROSS-REFERENCE TO RELATED APPLICATIONS

The present application claims the benefit of U.S. Provisional Application No. 62/324,739, filed Apr. 19, 2016, the entirety of which is hereby incorporated by reference.

### BACKGROUND

### Field

The present disclosure relates generally to the field of vehicle charging systems, and more specifically to plug and socket free charging systems for electric vehicles.

### Description of the Related Art

Plug-in hybrids and all-electric vehicles can be propelled by one or more electric motors using electrical energy stored in one or more rechargeable batteries or another energy storage device. Such vehicles must be periodically recharged.

A charger or charging connector at a charging station may be plugged into a charge port located on the vehicle to charge the vehicle's power source. While conventional low voltage power sources may be used to charge vehicle batteries, high voltage charging stations may replenish electric vehicle battery charge at a faster rate than the low voltage power sources.

Vehicles charge ports are commonly located in the same position where a gasoline intake is located on a gas powered vehicle. Similar to a gasoline intake, such charge ports are commonly covered by a movable door.

Charge ports allow for re-charging of the vehicle, communication between the vehicle and charging station, and provide a mechanical connection between the vehicle and charging station. Standards for charge ports have been proposed by Japan (e.g., CHAdeMO), China (e.g., GB/T 20234), and the IEC.

### SUMMARY

The devices, systems, and methods disclosed herein have several features, no single one of which is solely responsible for its desirable attributes. Without limiting the scope as expressed by the claims that follow, its more prominent features will now be discussed briefly. After considering this discussion, and particularly after reading the section entitled “Detailed Description” one will understand how the features of the system and methods provide several advantages over traditional systems and methods.

The present disclosure is generally directed to a plugless and socketless charging connector for an electric vehicle. In some aspects, the connection surface is substantially smooth, without any protrusions or indentations disposed thereon. The connection surface may be configured to contact at least a portion of the vehicle's exterior and transmit a current sufficient to charge a vehicle battery directly through the connection surface. The portion of the vehicle's exterior to be contacted by the charging connection may include a door panel, body panel, fender, bumper, or the like.

In some aspects, a conductive path is disposed in an exterior vehicle component. The conductive path may appear to be part of a door, fender, emblem, and the like. Current, sufficient to charge one or more batteries within the vehicle may pass through the conductive path. In some aspects, a charge port is also disposed within the vehicle. The charge port may be movable from at least a first position spaced away from the conductive path to a second position in contact with at least a portion of the conductive path.

In some implementations, a plugless and socketless charging connector for an electric vehicle includes a connection surface having a substantially smooth surface without any protrusions or indentations disposed thereon. The connection surface may be configured to contact at least a portion of the vehicle's exterior and transmit a current sufficient to charge a vehicle battery directly through the connection surface. The connection surface may include at least two conductive areas separated by non-conductive areas. The at least two conductive areas may have a potential difference therebetween during charging. The connection surface may be divided into at least three conductive areas that are wired as line, neutral, and ground. The connection surface may be at least partially concave and/or convex. The charging connector may include at least one magnet for securing the charging connector to the vehicle's exterior. The charging connector may have a connection surface that is shaped to mate with a portion of an exterior body panel of the vehicle.

In some implementations, a plugless and socketless charging connector for an electric vehicle includes a magnet configured to secure the charging connector to an exterior surface of the vehicle and a plug and socket free connection surface configured to be coupled to an exterior vehicle component. The connection surface may be capable of transmitting a current sufficient to charge the vehicle through at least a portion of the connection surface and through at least a portion of the exterior surface. The connection surface may include at least one indentation for receiving a portion of the exterior vehicle component. The at least one indentation itself may be incapable of securing the connection surface to the exterior of the vehicle.

In some implementations, a method of charging an electric vehicle without a plug and socket connection includes one or more of the following steps. The method may include, for example, placing a connection surface in contact with an exterior vehicle component. The method may include magnetically securing the connection surface to the exterior vehicle component. The method may include transmitting a current through the connection surface and through a conductive path passing through the exterior vehicle component. The method may also include routing the current to charge one or more batteries disposed within the vehicle. In some aspects, the routing step includes moving a charge port into contact with the conductive path. The exterior vehicle component may include a fender, a grille, an exterior door panel, an emblem, or a hood ornament.

In some implementations, a plugless and socketless charging connection for an electric vehicle includes an exterior vehicle component having a conductive path disposed therein. The conductive path may be capable of transmitting a current sufficient to charge the vehicle. The conductive path may have a first outwardly facing side and a second inwardly facing side. A charge port may be disposed within the vehicle. The charge port may be movable from at least a first position spaced away from the second side to a second position in contact with at least a portion of the second side. A spring may bias the charge port away from the second side. The charge port may include at least one magnet. The magnet may be an electromagnet.

In some implementations, a plugless and socketless charging connection for an electric vehicle includes a magnetic material for securing a charge port to an interior facing surface of the vehicle and a conductive path extending from the interior facing surface to an exterior facing surface of the vehicle. The conductive path may be capable of transmitting a current sufficient to charge the electric vehicle through the conductive path and to the charge port. The conductive path may be disposed within an exterior vehicle component. The exterior vehicle component may include a door panel, a fender, and a bumper.

In some implementations, a plugless and socketless system for charging an electric vehicle includes a conductive path disposed within a body component of the vehicle. The conductive path may have a first end and a second end. A charge port may be housed within the vehicle. The charge port may be movable from a first position spaced away from the first end to a second position in electrical contact with the first end of the conductive path. A charging station may be coupled to an electrical grid. The charging station may include a charging connection or charging connector that is configured to form an electrical connection with the second end of the conductive path. A spring may bias the charge port in the first position. The charging connection may include a connection surface that is substantially smooth without any protrusions or indentations disposed thereon. These and other features, aspects, and advantages of the present disclosure will be further described below.

### BRIEF DESCRIPTION OF THE DRAWINGS

The following is a brief description of each of the drawings. From figure to figure, the same reference numerals have been used to designate the same components of an illustrated embodiment. The drawings disclose illustrative embodiments and particularly illustrative implementations in the context of electric vehicles, such as hybrid and/or electric automobiles. They do not set forth all embodiments. Other embodiments may be used in addition to or instead. Conversely, some embodiments may be practiced without all of the details that are disclosed. Moreover, it is to be noted that the figures provided herein are not drawn to any particular proportion or scale, and that many variations can be made to the illustrated embodiments.

FIG. 1A is a schematic illustration of a charging system according to an exemplary implementation.

FIG. 1B is a front view of the charging connection of FIG. 1A.

FIGS. 2A-2B are schematic cross-sectional illustrations of the charging system of FIGS. 1A-1B.

FIGS. 3A-3B are similar to FIGS. 2A-2B and show schematic cross-sectional illustrations of the charging system in use with a curved exterior body panel of a vehicle.

FIGS. 4A-4B are similar to FIGS. 2A-2B and FIGS. 3A-3B and show schematic cross-sectional illustrations of the charging system in use with a receiving portion disposed on a vehicle.

FIG. 4C is a front perspective view of an electric vehicle having a receiving portion similar to the receiving portion of FIGS. 4A-4B. As shown, the receiving portion is disposed on the front and center portion of the electric vehicle

FIGS. 5A-5B are similar to FIGS. 1A-1B and schematically illustrate a charging system according to another exemplary implementation. FIG. 5B is a front view of the charging connector of FIG. 5A.

FIG. 6A is a rear perspective view of a charging connector according to an exemplary implementation.

FIG. 6B is a front perspective view of the charging connector of FIG. 6A.

FIG. 7 is similar to FIGS. 2B, 3B, and 4B and illustrates a side and partial cut-away view of the charging connector of FIGS. 6A-6B in contact with an exterior component of a vehicle.

FIGS. 8A-8B are front perspective views that illustrate an exemplary implementation of a flexible faced charging connector that is similar to the charging connector depicted in FIGS. 6A-6B and 7.

FIGS. 8C-8D are similar to FIGS. 8A-8B and show the flexible faced charging connector of FIGS. 8A-8B attached to different shaped surfaces.

FIGS. 9A-9C are similar to FIGS. 8A-8D and illustrate an exemplary implementation of a flexible faced charging connector. FIGS. 9A-9B are front perspective views that illustrate an exemplary implementation of a flexible faced charging connector.

FIG. 9C is an enlarged side view of the flexible faced charging connector of FIGS. 9A-9B.

### DETAILED DESCRIPTION

Battery powered electric vehicles (“EV's”) require periodic charging to replenish the charge on batteries. As used herein, the term “electric vehicle” and “EV” can refer to any vehicle that is partly (“hybrid vehicle”) or entirely operated based on stored electric power. Such vehicles can include, for example, road vehicles (cars, trucks, motorcycles, buses, etc.), rail vehicles, underwater vessels, electric aircraft, and electric spacecraft.

An EV charging station can be connected to an electric grid or other electricity generating device or source of electric energy. Charging stations can comprise a standard residential 120 volt Alternating Current (AC) electrical socket that connects to the vehicle by a cable with a standard electrical plug at one end for connecting to the residential socket, and a vehicle-specific connector at the other end for connecting to the EV. Household chargers utilizing 240 volt AC can also be installed to reduce charging time. Commercial and government-operated charging stations can also utilize 120 volt and 240 volt AC, or can utilize a Direct Current (DC) fast charge system of up to 1000 volts.

Electric and/or hybrid vehicles often have charge ports that are typically located along the side of the vehicle similar to gas tank inlets on combustion-engine-powered vehicles. However, in parking garages, both residential and public, it may not be practical for a charging station to be located along the side of a vehicle, particularly in parking areas designated for multiple electric vehicles where each vehicle may require a charging station. EV charge ports and/or their covers may be unsightly and may distract from a vehicle's curvatures and/or sight lines. In addition, traditional charging connectors often require a significant amount of force to couple and uncouple the connector to the vehicle. This may be difficult for some operators. The present disclosure may implement one or more magnets to hold the charging connector in electrical contact with the charge port.

The present disclosure may also allow for a charge port to be positioned in more than one location on the vehicle. For example, a vehicle may have a charge port on one or more of the front, rear, left side, and/or right side of the vehicle. In some aspects, the charge port may be integrated into an exterior design feature of the vehicle. For example, a vehicle logo may be utilized as a charge port. Current may be passed through sections of the vehicle's logo, through an exterior vehicle panel, and into a charge port positioned on the opposite side of the panel. In some aspects, a conductive path between a charging connector and a charge port may allow for the charge port to be visually unobtrusive, or even an aesthetically attractive part of the vehicle.

In some aspects, a charge port is spaced away from the exterior vehicle panel when charging is not taking place. This gap may provide clearance between the charge port and the vehicle body and other structures that form the vehicle. Having the charge port spaced away from the conductive path and/or exterior surfaces of the vehicle may increase safety and reduce the risk of current leakage out of the charge port and/or reduce the risk of charge building up on the vehicle's exterior. The aforementioned problems, among others, are addressed in some embodiments by the charging systems disclosed herein.

Disclosed herein are devices, systems, and methods that allow for the charging of an EV directly through a conductive path located in one or more body panels of a vehicle, components of the vehicle, or other non-traditional charging path structures. In this way, the need for a traditional charging plug/socket structure is eliminated. In contrast, the connection between a charging connector and a charge port may be plug and socket free. In contrast to an inductive charging method, the present disclosure relates to the direct transmission of power from a charging station, through a conductive path in an exterior vehicle component, and to one or more energy stores within the vehicle.

The charging connector may have a connection surface that is a substantially smooth surface without any perceptible protrusions or depressions disposed thereon. Such a connection surface may be placed into contact with a surface of the vehicle that also has substantially smooth surface without any perceptible protrusions or depressions disposed thereon. In some embodiments the charging connector connection surface may either protrude from or be depressed into the surface between 1 mm and 0.01 mm. Current that is sufficient to charge the vehicle may pass from the connection surface, through the surface of the vehicle and, be routed to a charge the batteries in the vehicle. The connection surface may be configured to contact a curved body panel. For example, the connection surface may be convex, concave, or a mix of both. Thus, the connection surface may be shaped to substantially mate with a curved exterior surface of the vehicle.

In some implementations, the charging connector has a connection surface that includes one or more protrusions and/or depressions disposed thereon. For example, the connection surface may be shaped to mate with corresponding depressions and/or protrusions of an external vehicle component. In some aspects, the conductive path includes one or more raised surfaces on the vehicle. The raised surfaces may be part of a design element, logo, or emblem on the exterior of the vehicle. The connection surface may thus have corresponding indentations, depressions, or receiving spaces for receiving such protrusions on the vehicle. Such raised surfaces on the vehicle and corresponding indentations, depressions, or receiving spaces may allow for better electrical contact between the connection surface and the conductive path.

One or more magnets may be used to hold the connector in place with respect to the charge port. In this way, the need for a physical, mechanical coupling between a charging connector and a charge port (e.g., a plug and socket type connection) may be eliminated. A magnet may provide the force required to hold the charging connection in contact with the vehicle. Thus, no physical force for overcoming plug/socket friction when connecting or disconnecting the charging connector may be needed to be provided by a user.

In some aspects, only the magnetic force holds the charging connector in place and no other mechanical mechanisms are used. The magnetic force may be sufficient to hold the charging connection in contact with the vehicle such that the charging connector does not move with respect to the vehicle. In some aspects, the magnet is an electromagnet, such that the magnetic force may be selectively turned on and/or off. One or more magnets may be disposed on or within the charging connector, charge port, or electric vehicle component. In some embodiments, a mechanical locking force may be used to attach and hold the connector in place with respect to the charge port.

The charging connector may be configured to transmit a current through a conductive path in an external vehicle component or portion thereof. The vehicle component may be an exterior panel, fender, door, wheel well, bumper, grille, hood, trunk, cargo bed, roof, and/or underside. In some aspects, the component is not covered by a door or hatch or the like. The component may be a logo, design element, emblem, hood ornament, and the like.

In some embodiments, it is desirable that the charge port and/or position on the car where the charge port or conductive path is located cannot be visibly detected by a viewer of the automobile. In some embodiments, it is desirable to minimize the visibility of the charge port and/or the conductive path to the user. Thus, the conductive path and/or charge port may be hidden and/or camouflaged from view without the use of a cover or door. For example, the conductive path may appear as a substantially flat and smooth surface that is contiguous and smooth with surrounding surfaces of the vehicle. In some aspects, the conductive path appears to be the same color as the exterior and/or surrounding parts of the vehicle upon superficial viewing or inspection. However, in some aspects, upon closer inspection for example, different colorations and/or materials may be detected by a viewer. In some aspects, the conductive path appears as a vehicle logo and/or front/rear emblem. In this way, different conductive materials may be used without obvious detection by a viewer. In some aspects, the conductive path is designed to appear as portion of or the entire front/rear hood ornament.

Having a vehicle design element and/or emblem included as a part of the conductive path may render the conductive path less visibly noticeable and can even be an attractive part of the vehicle. For example, various types of conductive materials may be needed to form a plurality of insulated and/or electrically isolated conductive paths through an external body component of the vehicle. In order for a circuit to be formed between the charge port and the charging connector, at least two electrical paths through the external body component may be formed. When two copper electrical paths are formed through a body panel, for example, the paths may be visible upon close inspection of the panel—even if the smoothness and/or coloration of the paths and panels are closely matched. The outwardly facing portions of the paths may include smooth features, raised features and/or depressed features that are at least partially integrated into a body panel surface or a design element or emblem or logo or ornament. In this way, the exterior facing portions of the conductive path may be disguised and/or camouflaged from view and are less likely to be discerned as a charging connection area by casual viewers of the vehicle.

A charge port may be positioned on the opposite side of the conductive paths. The charging connector may be coupled to a charging station (e.g. a power source) and coupled to one side of the conductive path and the charge port may be coupled to the opposite side of the conductive path. Thus, the charge port may be “hidden” from view without using a door or cover.

In some aspects, the charge port may be spaced away from the opposite side of the conductive path at least when the vehicle is not being charged and or when the charging connector is not in contact with the conductive path. This may provide an electrical clearance space between the charge port and the conductive path. In this way, charge from the vehicle batteries may not creep and/or leak into the conductive path and/or into other vehicle components. In some aspects, the gap or space between the charge port and the conductive path is between 2-0.05 inches when the vehicle is not being charged and or when the charging connector is not in contact with the conductive path.

In some aspects, the charge port may be biased in a position that is spaced away from the conductive path. The charge port may include one or magnets. The magnets may be electromagnets. Additionally or alternatively, one or more magnets may also be included in the charging connector. The magnets may be electromagnets. The magnets of the charge port and charging connector may be of opposite polarity. The magnets of the charging connector and/or charge port may thus impart a force on the charge port sufficient to overcome the biasing force such that the charge port moves towards and into contact with the conductive path.

In some aspects, the magnets of the charge port and/or the charging connector are activated when the charge port and/or the charging connector are in relatively close proximity to each other. For example, when the charging connector is placed into contact with outer surface of the conductive path, electromagnets of the charge port and/or the charging connector may be activated to bring the charge port into contact with the inner surface of the conductive path. Current may then flow from the charging connector, through the conductive path, and to the charge port. Current received by the charge port may be used to charge one or more batteries within the electric vehicle. In some aspects, the charge port and the charging connector may have connection surfaces that are generally rectangular in shape and may have at least one magnet disposed in each corner. In some aspects, the charge port and/or the charging connector may include materials that can be magnetized. Such materials include, for example, iron, nickel, cobalt, and the like.

The conductive path, charging connector, and charge port may be capable of transmitting electric signals in order to transmit data to and from the vehicle and the charging station. Such data links may, for example, be used to transmit electric signals indicative of charging levels, safety information, temperatures, and the like. The conductive path, charging connector, and charge port may be capable of transmitting more than one charging current at a time and/or electrical data signals at the same time.

Other methods of data transmission may also be utilized instead and/or in addition to electronic signals. For example, a fiber optic path may be configured to pass through the vehicle and be coupled to corresponding portions of the charging connector and charge port. Thus, fiber optic signals may be used to transmit data to and from the vehicle and the charging station. Wireless transmission of data and/or signals between the vehicle and the charging station is also contemplated.

The conductive path, charging connector, and charge port may be divided as necessary to transmit the desired number of charging currents and/or signal currents. For example, different sections or areas or features of the charging connection may be used for various signals such as AC lines, DC lines, ground, data, and the like. The charging connection may be configured such that there is no hazardous voltage potential across two portions of the charging connection or to ground unless the charging connection is properly secured to the conductive path and/or charge port.

The conductive path, charging connector, and charge port may be divided into portions by various means. The conductive path, charging connector, and charge port may include various materials. Conductive materials may be separated by non-conductive materials in various manners. A conductive path through a vehicle component may include a conductive material that is surrounded by a non-conductive material. For example, a copper path may extend through a plastic exterior body panel. The copper path may be coupled to a conductive portion of the charging connector and a conductive portion of the charge port such that a current may flow from the charging connector, through the conductive path, and into the charge port. In some aspects, the various materials are formed into a substantially smooth surface without any protrusion or depressions formed thereon. For example, a door panel or fender may be formed with a conductive path disposed therein without having any additional protrusion or depressions on the door panel or fender than would be in a typical automobile.

In some implementations, a conductive path may be divided and/or separated by non-conductive materials to form a plurality of conductive paths. For example, a conductive path may be formed by inserting a copper section that is inlayed with plastic dividers into an exterior body panel of a vehicle.

In some implementations, the charging connector includes one or more heat sinks. The heat sink may include a liquid coolant that circulates within the charging connector. The heat sink may help cool the charging connector, conductive path, and/or charge port. Similarly, the conductive path and/or charge port may also include one or more heat sinks. In some aspects, the heat sinks may be configured to conduct heat away from the conductive path.

In some implementations, the charging connector includes an air blower. The air blower may blow air and/or gas out of the charging connector in order to help clean an exterior surface of the vehicle and/or a portion of the conductive path. For example, dust and other particulate matter may impair the transfer of current from the charging connector to the conductive path. Thus, the charging connector may be configured to blow pressurized air and/or other gas to remove dust and other particulate from the exterior surface of the vehicle to help ensure that a good electrical connection is established between the charging connector and the conductive path.

The conductive path may have an exterior surface that includes a hydrophobic and/or anti-dust coating. Such coatings may help repel water and/or dust to further help ensure that a good electrical connection is established between the charging connector and the conductive path. In some aspects, the charging connection has an exterior surface that includes a hydrophobic and/or anti-dust coating.

To assist in the description of various components of the vehicle charge port systems, the following coordinate terms are used throughout the figures. An “outward direction” refers to a direction substantially normal to an exterior surface of a vehicle, and refers to motion from the interior of the vehicle toward and beyond the exterior surface of the vehicle. An “inward direction” refers to a direction substantially parallel to the outward direction, but in the opposite direction, toward the interior of the vehicle. A longitudinal direction generally extends along the length of a vehicle from the front to rear (e.g. from the front bumper to the rear bumper). A lateral direction is perpendicular to the longitudinal direction and generally extends along the width of a vehicle from the side to side. A vertical direction is perpendicular to both the longitudinal and lateral direction and generally extends from the bottom of the car to the top (e.g. from the tires to the roof).

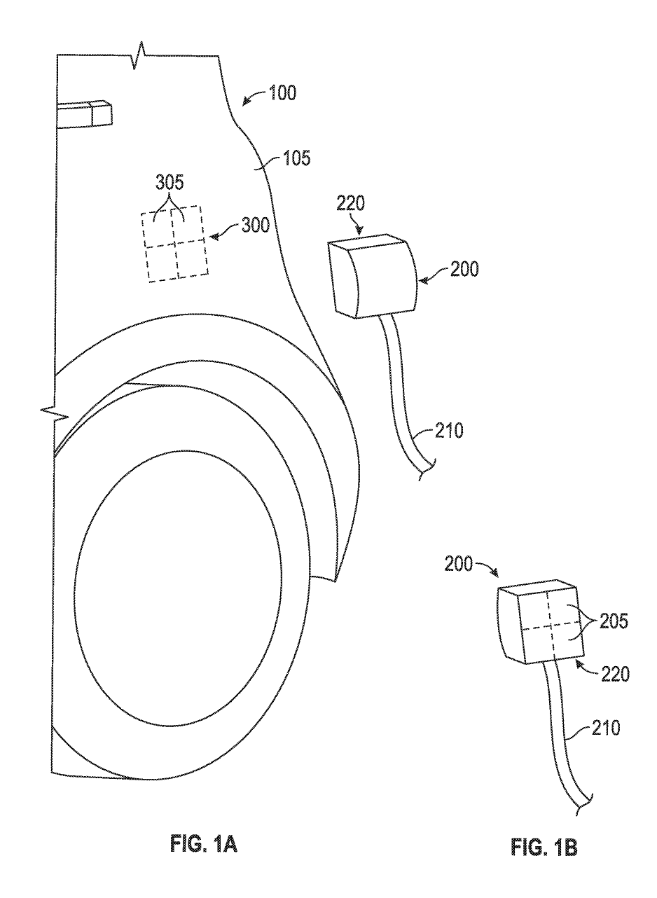

Turning now to FIGS. 1A-1B, a charging system for an electric vehicle according to an exemplary implementation is illustrated. As shown, an electric automobile 100 may include a conductive path 300 that is integrated into a fender 105. The conductive path 300 may have an exterior surface that is contiguous with the fender 105. The conductive path 300 may be a substantially smooth surface without any protrusions or indentations disposed thereon. The conductive path 300 may be divided into two or more conductive areas 305. The conductive areas 305 may be divided by non-conductive materials such that the conductive areas 305 are electrically isolated from one another. Thus, a potential difference may be provided between two different conductive areas 305.

While four conductive areas 305 are shown in FIGS. 1A-1B, more or less conductive 305 areas may be provided as desired. In some implementations, three conductive areas are used and are wired to correspond to line in, neutral, and ground. In some aspects, there are at least six conductive areas 305. In some aspects there are at least nine conductive areas 305. Furthermore, while the conductive areas 305 are shown as generally rectangular in shape, any shape or combination of shapes and configurations are contemplated.

The conductive path 300 may be coupled to a charge port (not shown) disposed behind the fender 105. At least a portion of the conductive path 300 may lead to battery management circuitry. At least a portion of the conductive path 300 may eventually lead to one or more batteries disposed within the vehicle 100.

A charging connector 200 may be coupled to a charging station (not shown) with a cable 210. The charging station may be coupled to an electrical supply source, such as an electrical grid. The cable 210 may transmit electrical current that is sufficient to charge an electric vehicle. Current may be supplied as AC or DC current. The charging station may be configured to supply 120 or 240 volt AC, 300-500 volts DC, or other voltages, powers, and currents as desired.

As best seen in FIG. 1B, the charging connector 200 may include a connection surface 220 that is also substantially smooth and free of any protrusions or indentations. Thus, the connection surface 220 may be configured to mate with the portion of the conductive path 300 disposed on the exterior surface of the fender 105. Similar to the conductive path 300, the connection surface 220 may include a plurality of conductive areas 205 that are configured to mate with the conductive areas 305 of the conductive path 300. The conductive areas 205 may be separated by non-conductive materials. Thus, a potential difference may be provided between two different conductive areas 205. The charge connection surfaces may be air cooled, liquid cooled, or made of a substantially heat resistant material.

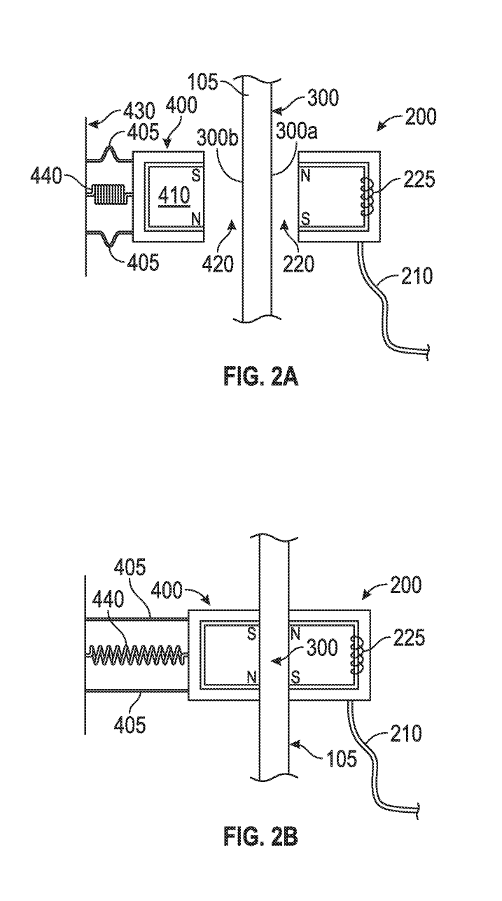

FIG. 2A illustrates that a charge port 400 may be positioned in a location generally behind the fender 105. The conductive path 300 may travel between an exterior side 300a of the fender 105 and an interior side 300b of the fender 105. The charge port 400 may be configured to carry current sufficient to charge one or more batteries within the vehicle 100. Thus, current may flow from the charging connector 200, through the conductive path 300, and into the charge port 400. The charge port 400 may further route the current to battery management circuitry, switches, batteries and the like. The charge port 400 may form a circuit through the charging station at least when the charge port 400 and the charging connector 200 are each in electrical contact with the conductive path 300.

Similar to the conductive path 300 and the connection surface 220, the charge port 400 may also include a connection surface 420 that includes a plurality of conductive areas that are configured to mate with the conductive areas 305 of the conductive path 300. The conductive areas may be separated by non-conductive materials. Thus, a potential difference may be provided between two different conductive areas.

As shown in FIG. 2A, the charge port 400 may be spaced away from the conductive path 300 at least when the vehicle 100 is not being charged. A spring 440 may provide a biasing force that pulls the charge port 400 away from the interior side 300b. The spring 440 may be coupled to an interior portion of the vehicle. In this way, the connection surface 420 of the charge port 400 may be electrically isolated from the conductive path 300 at least when the vehicle 100 is not being charged. It will be understood that while spring 440 is depicted as a coil spring in some embodiments the spring 440 may be a leaf spring, cantilevered arm, or other means of providing a biasing force that are well known in the art.

The charging connector 200 may include an electromagnet 225. The charge port 400 may include a magnet of opposite polarity and/or include a material that is capable of being magnetized. The electromagnet 225 may provide a force sufficient to overcome the biasing force of the spring 440. Thus, in operation, the charging connector 200 may be placed into contact with the exterior side 300a of the conductive path 300 as shown in FIG. 2B. The electromagnet 255 may be activated. The electromagnet 255 may secure the charging connector 200 to the exterior side 300a of the conductive path 300 and/or to the door panel. The electromagnet 255 may also provide a force to move the charge port 400 from a position spaced away from the interior side 300b to a position in contact with the interior side 300b. In this way a circuit is formed between the charging station and the electric vehicle. Current may be routed through one or more cables 405 coupled to the charge port 400.

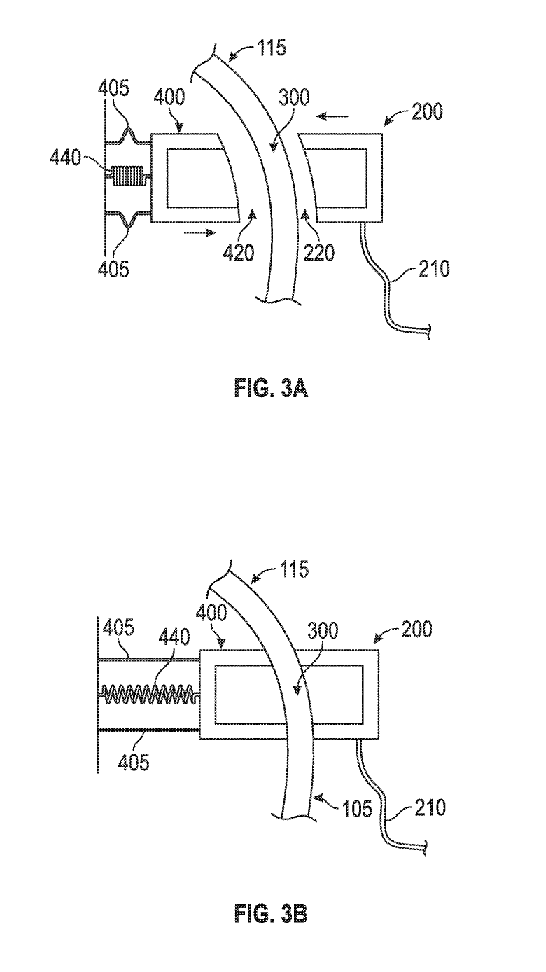

As shown in FIGS. 3A-3B, the charging connector 200, conductive path 300, and charge port 400 may be configured to operate in conjunction with a curved exterior body panel 115. Thus, the charging connector 200 may include a connection surface 220 that is curved and/or generally concave. The charge port 400 may include a connection surface 420 that is curved and/or generally convex. Locating the conductive path 300 in a curved surface may further make the charging connection system less visibly noticeable to viewers of the vehicle.

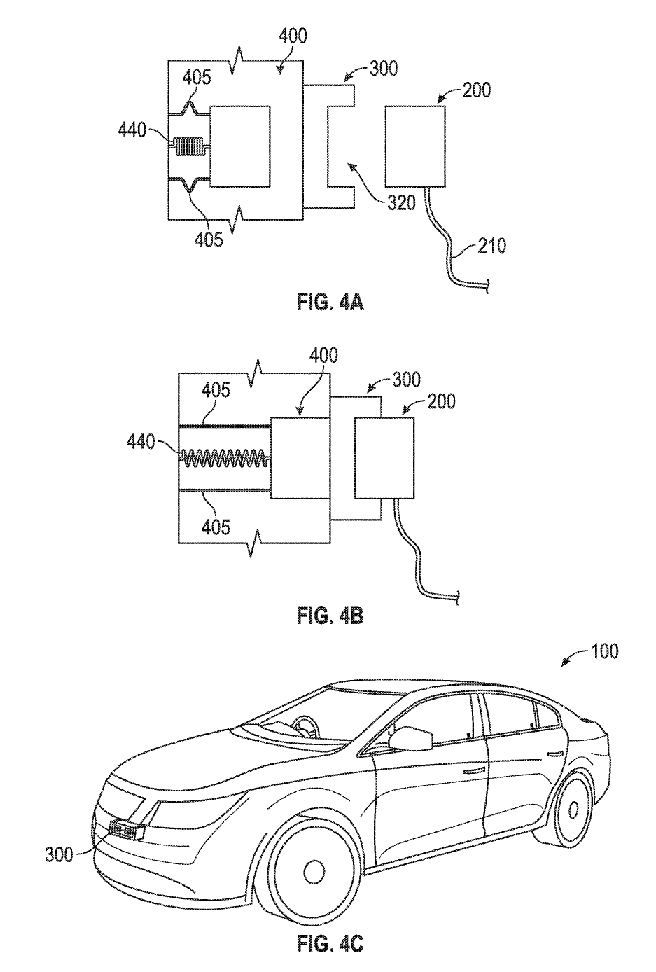

As shown in FIGS. 4A-4B, the conductive path 300 may include a receiving space 320 for the charging connector 200. Thus, in some implementations, the conductive path 300 may have visibly noticeable portions, indentations, and/or protrusions. Such a conductive path 300 may provide a user with an ability to easily locate the conductive path 300. As shown in FIG. 4C, such a conductive path 300 may be located in the front bumper and or front grille assembly of the vehicle 100. In some aspects, the conductive path 300 is configured as a car emblem, logo, or hood element. In this way, the conductive path 300 may be less visibly noticeable.

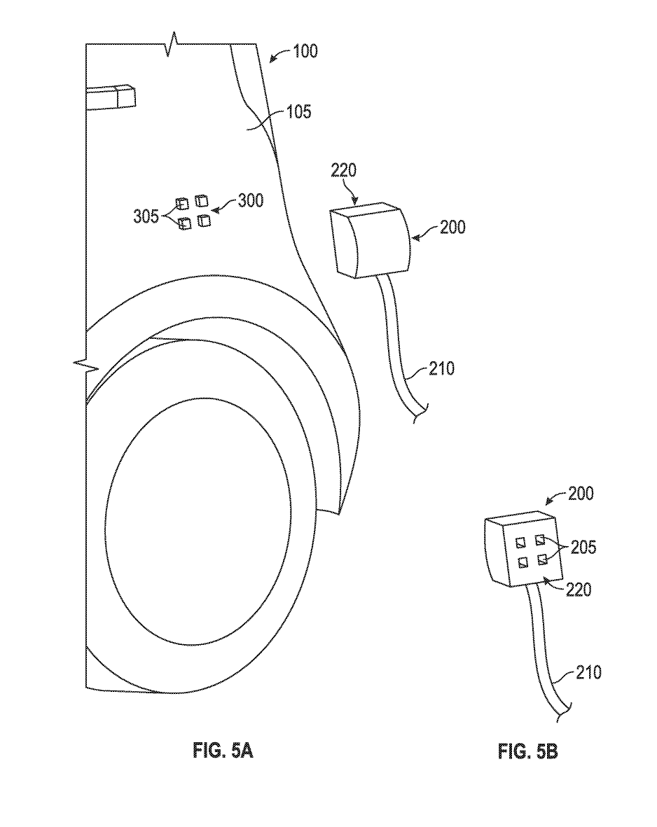

As shown in FIG. 5A, the conductive path 300 may include one or more conductive areas 305 that include protrusions. Likewise, as shown in FIG. 5B, the charging connector 200 may include a connection surface 220 that includes conductive areas 205 that include indentations or receiving spaces for the protrusions. Unlike a plug and socket connection however, the interaction of the protrusions and receiving spaces may be incapable of physically securing the charging connector 200 to the vehicle. Rather, the protrusions and receiving spaces may be a vehicle design element or emblem. In this way, the conductive path 300 may be an aesthetically desirable component of the automobile.

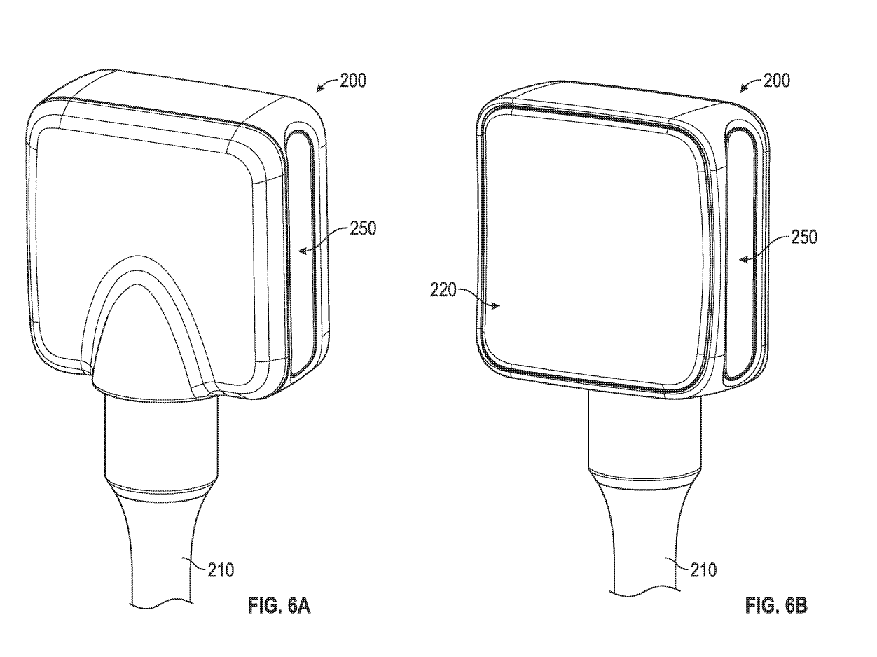

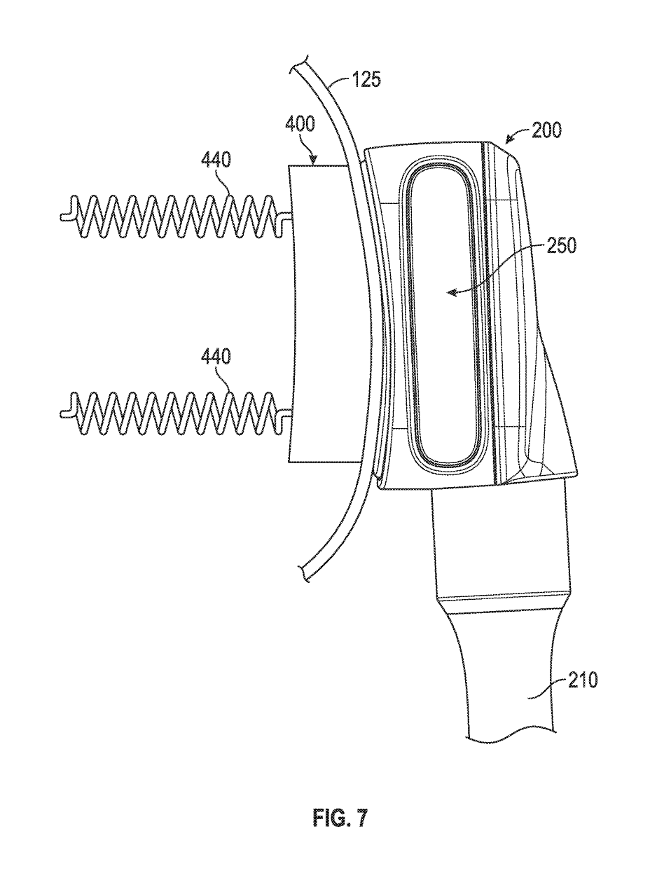

As shown in FIGS. 6A-6B, the charging connector 100 may include a connection surface 220 that is substantially smooth without any protrusions or indentations disposed thereon. The connection surface 220 may be at least partially concave. Side indentations 250 may be provided to allow a user a place to grip the charging connector 200 during handling. As shown in FIG. 7, the charging connector 200 may be configured to mate with at least a portion of an exterior vehicle component 125. The charging connector 200 may include a magnet that pulls a charge port into contact with the interior surface of the exterior vehicle component 125. Current sufficient to charge the vehicle may thus flow through a conductive path disposed within the exterior vehicle component 125.

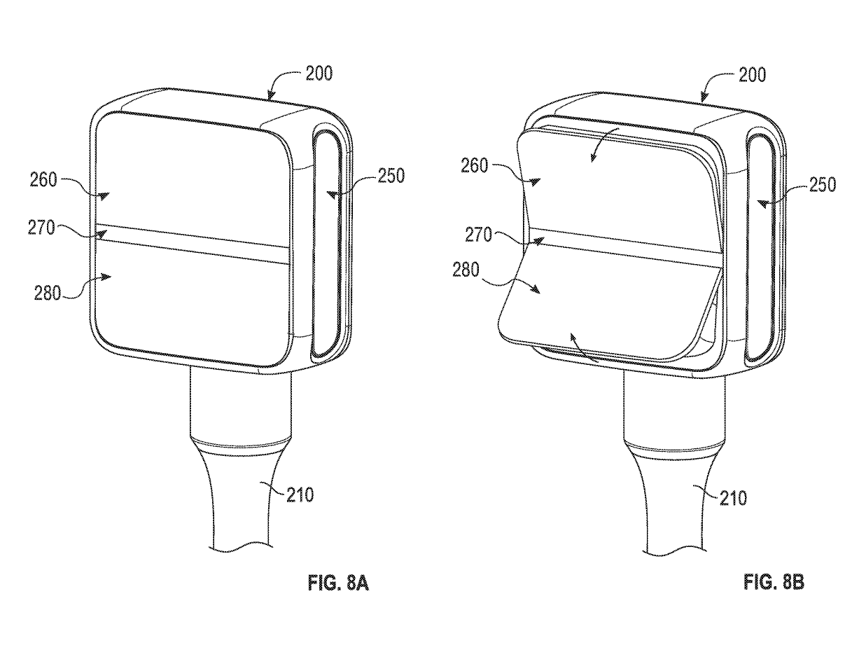

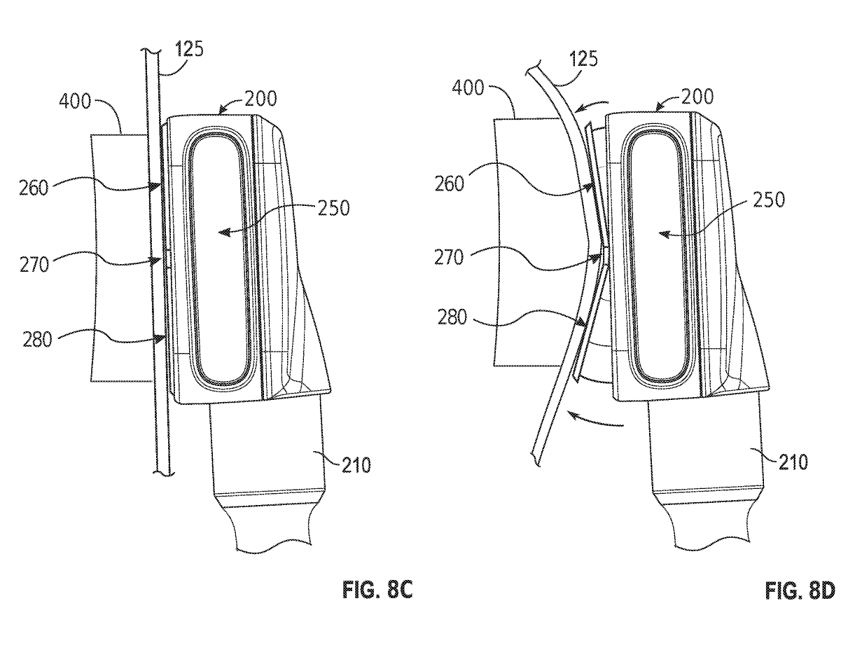

As shown in FIGS. 8A-8B, the charging connector 200 may be a flexible charge connector comprising a top connection surface 260 and a bottom connection surface 280. The top connection surface 260 and bottom connection surface 280 may be separated by a flexible member 270. Flexible member 270 may be made of any suitable flexible material such as rubber, plastic, metal, composite materials, or fibrous materials. The charging connector may be configured so that top connection surface 260 and bottom connection surface 280 pivot around flexible member 270 by as much as 45 degrees. This pivoting motion may provide for an optimal connection to a conductive path 300 that is placed on an angled surface.

FIG. 8A illustrates an exemplary charging connector with top connection surface 260 and bottom connection surface 280 in and un-flexed position and flush against the surface of charge connector 200. FIG. 8B illustrates an exemplary charging connector with top connection surface 260 and bottom connection surface 280 in a flexed position with both top connection surface 260 and bottom connection surface 280 pivoting around flexible member 270. In this flexed position the top connection surface 260 and bottom connection surface 280 protrude out from charge connector 200.

FIGS. 8C-8D illustrate two exemplary use cases for the flexible charge connector. As depicted in FIG. 8C, the charge connector 200 may be configured to couple to the charge port 400 through a substantially planar exterior vehicle component 125. When coupling across a substantially planar exterior vehicle component 125 top connection surface 260 and bottom connection surface 280 may be in an un-flexed position as depicted in FIG. 8A. However, when the exterior vehicle component 125 has a curved or polygonal shape, as depicted in FIG. 8D, then top connection surface 260 and bottom connection surface 280 may be a flexed position as depicted in FIG. 8B.

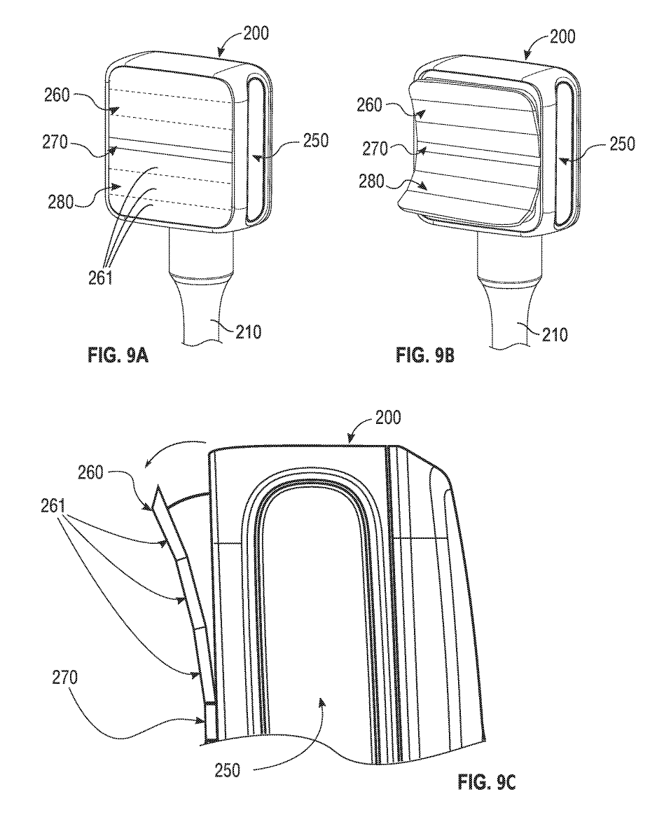

FIGS. 9A-9C illustrate a further embodiment of a flexible charge connector. FIG. 9A depicts a top connection surface 260 and bottom connection surface 280 wherein both the top connection surface 260 and the bottom connection surface 280 comprise a plurality of interlocking flexible surfaces 261. These plurality of interlocking flexible surfaces 261 may comprise any arbitrary number of individual interlocking flexible surfaces 261a, 261b, . . . 261n so that the connection surface is flush to a spherical surface. Each interlocking flexible surface 261 may pivot so that the top connection surface 260 and bottom connection surface 280 form a substantially arched surface as depicted in FIG. 9B. FIG. 9C illustrates an enlarged view of the top connection surface 260 forming a substantially arched surface from the pivots of each of the individual planar interlocking flexible surfaces 261.

It will be understood that while the embodiments described herein are focused primarily on automotive charging, these techniques may be readily adapted by those skilled in the art for use in clean rooms, medical facilities, hermetically sealed environments, or any area where a traditional insertion electric connection is undesirable.

The foregoing description and claims may refer to elements or features as being “connected” or “coupled” together. As used herein, unless expressly stated otherwise, “connected” means that one element/feature is directly or indirectly connected to another element/feature, and not necessarily mechanically. Likewise, unless expressly stated otherwise, “coupled” means that one element/feature is directly or indirectly coupled to another element/feature, and not necessarily mechanically. Thus, although the various schematics shown in the Figures depict example arrangements of elements and components, additional intervening elements, devices, features, or components may be present in an actual embodiment (assuming that the functionality of the depicted circuits is not adversely affected).

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

It is to be understood that the implementations are not limited to the precise configuration and components illustrated above. Various modifications, changes and variations may be made in the arrangement, operation and details of the methods and apparatus described above without departing from the scope of the implementations.

Although this invention has been described in terms of certain embodiments, other embodiments that are apparent to those of ordinary skill in the art, including embodiments that do not provide all of the features and advantages set forth herein, are also within the scope of this invention. Moreover, the various embodiments described above can be combined to provide further embodiments. In addition, certain features shown in the context of one embodiment can be incorporated into other embodiments as well.

What is claimed is:

1. A plugless and socketless charging connector for an electric vehicle comprising:
a connection surface that is substantially smooth, without any protrusions or indentations disposed thereon, the connection surface configured to contact at least a portion of the vehicle's exterior and transmit a current sufficient to charge a vehicle battery directly through the connection surface.

2. The charging connector of claim 1, wherein the connection surface comprises at least two conductive areas separated by non-conductive areas, the at least two conductive areas having a potential difference therebetween during charging.

3. The charging connector of claim 2, wherein the connection surface is divided into at least three conductive areas that are wired as line, neutral, and ground.

4. The charging connector of claim 1, wherein the connection surface is concave.

5. The charging connector of claim 1, wherein the connection surface is convex.

6. The charging connector of claim 1, wherein the charging connector includes at least one magnet for securing the charging connector to the vehicle's exterior.

7. The charging connector of claim 6, wherein the at least one magnet is an electromagnet.

8. The charging connector of claim 1, wherein the connection surface is shaped to mate with a portion of an exterior body panel of the vehicle.

9. The charging connector of claim 8, wherein the connection surface is shaped to mate with a portion of a bumper.

10. A plugless and socketless charging connector for an electric vehicle comprising:
a magnet configured to secure the charging connector to an exterior surface of the vehicle; and
a plug and socket free connection surface configured to be coupled to an exterior vehicle component, the connection surface capable of transmitting a current sufficient to charge the vehicle through at least a portion of the connection surface and through at least a portion of the exterior surface.
